(19) United States
(12) Patent Application Publication
(10) Pub. No.: US 2005/0239035 A1
(43) Pub. Date: Oct. 27, 2005

(54) Method and system for master teacher testing in a computer environment

(76) Inventors: William G. Harless, Bethesda, MD (US); Michael G. Harless, Rockville, MD (US); Marcia Z. Zier, Bethesda, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/102,951

(22) Filed: Apr. 11, 2005

Related U.S. Application Data
(63) Continuation-in-part of application No. 10/438,168, filed on May 13, 2003.

(51) Int. Cl. G09B 3/00

(52) U.S. Cl. 434/350

(57) ABSTRACT

A method of administering an interactive examination between a user and a teacher. The method comprises: displaying the examination content sequence; receiving an utterance from the user; matching the utterance to one of a phonetic clone associated with a correct answer and a phonetic clone associated with an incorrect answer; and determining if the utterance is associated with the correct answer.

### CROSS REFERENCE TO RELATED APPLICATION

This patent application is a continuation-in-part and claims the benefit of priority of U.S. patent application Ser. No. 10/438,168, entitled “Method and System for Simulated Interactive Conversation”, filed May 13, 2003, which is incorporated herein by reference. This application was filed simultaneously with U.S. patent application Ser. No.______, entitled “Method and System for Master Teacher Knowledge Transfer in a Computer Environment,” which is incorporated herein by reference.

### TECHNICAL FIELD

The invention relates to the field of on-line education and evaluation, and, more specifically, a system and method that allows teachers in a computerized environment to engage in direct dialogue with students about educational material and to monitor dynamic tests regarding that material.

### BACKGROUND

Technology has become an important factor in higher education. Schools have emerged and gained accreditation with curricula delivered to students over the Internet. This form of education is variously known as “distance learning” or “E-learning” or “On-line learning.” Students enrolled in these programs can obtain diplomas, undergraduate, and graduate degrees, often fully accredited, without ever setting foot in a classroom or on a campus. Also, these students may be awarded diplomas and degrees without ever having any personal association with a teacher or the faculty, and likely would not know them if they saw them. In effect, the on-line education industry provides an extremely depersonalized form of education, and, without exception, all current computer network-driven learning models share the same deficiency: the absence of face-to-face contact with the teacher.

Many problems also exist in on-campus higher education today. Enrollment has grown exponentially with the maturation of the baby boomer generation. Classrooms are crowded and teachers are scarce; the classroom lectures that are not conducted by superior teachers are inefficient as a learning methodology—students are passive, bored, and subject to numerous distractions during the lecture. The faculty/student ratios are diminished, and the skills, talents, and knowledge of university teachers are not consistent across schools. Therefore, the transfer of knowledge from faculty to student is unequal. As a result, the quality of education is suffering; educators and administrators must struggle to maintain educational standards. The problems on the conventional campuses represent a “foot hold” for on-line learning, the development of which is rapidly increasing throughout curricula at all levels of education. But, implementation of on-line learning capabilities on campus also de-personalizes the student's education.

A virtual dialogue learning paradigm can enhance the educational quality of both on- and off-campus programs. Since the educational objective of virtual dialogue is to capture the knowledge and experiences of real teachers and make them available to anyone who is interested through a direct, face-to-face interview, a virtual dialog paradigm uniquely embodies the much-desired capability of personalizing the computerized learning process.

Potentially, the virtual dialogue learning paradigm could transform formal education from a crowded lecture hall to individualized, face-to-face knowledge transfer sessions between each student and the instructor. Every student could learn the material from the master teacher, who would be in cyberspace available for conversations with anyone at anytime, even with everyone at the same time.

Also, a major component of any educational experience is testing to quantitatively measure a student's gain in learning. Current testing methods are typically sterile and removed from the environment in which the student learned the material. Opportunities for immediate reinforcement and improved retention of knowledge that are inherent in contiguous testing are essentially lost due to the nature of conventional testing methods and procedures.

In addition, current testing methods do not enable the teacher to monitor the student's test responses except in after-the-fact grading, and the educational value of making the test an integral part of the learning experience is lost. There is not opportunity in the current testing system for the teacher to provide immediate, individual feedback to an individual's right or wrong answers, no capability of refreshing the student's memory during the exam, or to provide the right answer on request.

The present invention addresses the above problems and is directed to achieving at least one of the above stated goals.

### SUMMARY OF THE INVENTION

A method of generating an interactive examination between a user and a teacher is provided. The method comprises: assigning a phrase associated with a correct answer to a question stored as an examination content sequence, wherein the examination content sequence comprises a content clip of the teacher posing the question; assigning a phrase associated with an incorrect answer to the question; parsing the phrases to produce respective phonetic clones; and associating the respective phonetic clones with the respective answers.

In accordance with a further embodiment of the invention, a method of administering an interactive examination between a user and a teacher is provided. The method comprises: displaying the examination content sequence; receiving an utterance from the user; matching the utterance to one of a phonetic clone associated with a correct answer and a phonetic clone associated with an incorrect answer; and determining if the utterance is associated with the correct answer.

In accordance with a further embodiment of the invention, a system for generating an interactive examination between a user and a teacher is provided. The system comprises: a display for displaying the teacher; a memory; and a processor, coupled to the memory and the display. The processor is operable to: assign a phrase associated with a correct answer to a question stored as an examination content sequence, wherein the examination content sequence comprises a content clip of the teacher posing the question; assign a phrase associated with an incorrect answer to the question; parse the phrases to produce respective phonetic clones; and associate the respective phonetic clones with the respective answers.

In accordance with a further embodiment of the invention, a system for administering an interactive examination between a user and a teacher is provided. The system comprises: a display for displaying the teacher; a memory; and a processor, coupled to the memory and the display. The processor is operable to: display the examination content sequence; receive an utterance from the user; match the utterance to one of a phonetic clone associated with a correct answer and a phonetic clone associated with an incorrect answer; and determine if the utterance is associated with the correct answer.

The foregoing summarizes only a few aspects of the invention and is not intended to be reflective of the full scope of the invention as claimed. Additional features and advantages of the invention are set forth in the following description, may be apparent from the description, or may be learned by practicing the invention. Moreover, both the foregoing summary and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate a system consistent with the invention and, together with the description, serve to explain the principles of the invention.

FIG. 1 is an illustration of a system consistent with the present invention in its operating environment.

FIG. 2 is a block diagram of a conversation platform 110 consistent with the present invention.

FIG. 3 is a block diagram of an authoring platform 300 consistent with the present invention.

FIG. 4a is an illustration of a display screen at a prompting state consistent with the present invention.

FIG. 4b is an illustration of a display screen during an examination state consistent with the present invention.

FIG. 5 is a flowchart of an author process and a user interaction process consistent with the present invention.

FIG. 6 is a flowchart of a video editing process consistent with the present invention.

FIG. 7 is a flowchart of a phoneme generating process consistent with the present invention.

FIG. 8 is a flowchart of a first partial parsing process consistent with the present invention.

FIG. 9 is a flowchart of a second partial parsing process consistent with the present invention.

FIG. 10 is a flowchart of a first meaning-based process consistent with the present invention.

FIG. 11 is a flowchart of a second meaning-based process consistent with the present invention.

FIG. 12 is a more detailed flowchart of an interactive examination process consistent with the present invention.

### DETAILED DESCRIPTION

Reference will now be made in detail to the present exemplary embodiments consistent with the invention, examples of which are illustrated in the accompanying drawings. Wherever possible, the same reference numbers will be used throughout the drawings to refer to the same or like parts.

The applicants' patent application referenced above and entitled, “Method and System for Simulated Interactive Conversation,” provides a method of simulating interactive communications between a user and a human subject. The additional disclosure material provided in this continuation-in-part application leverages and improves upon the teachings of the aforementioned application to provide an interactive testing environment using a “Master Teacher.” Master Teacher is the term used to denote the simulated teacher and test administrator persona with whom the student interacts when using the system described.

Systems consistent with the present invention may provide a new educational paradigm using the Master Teacher and a method where knowledge gain may be accelerated, grades may improve, and educational standards may be elevated. Systems consistent with the present invention are directed to achieving one or more of these goals.

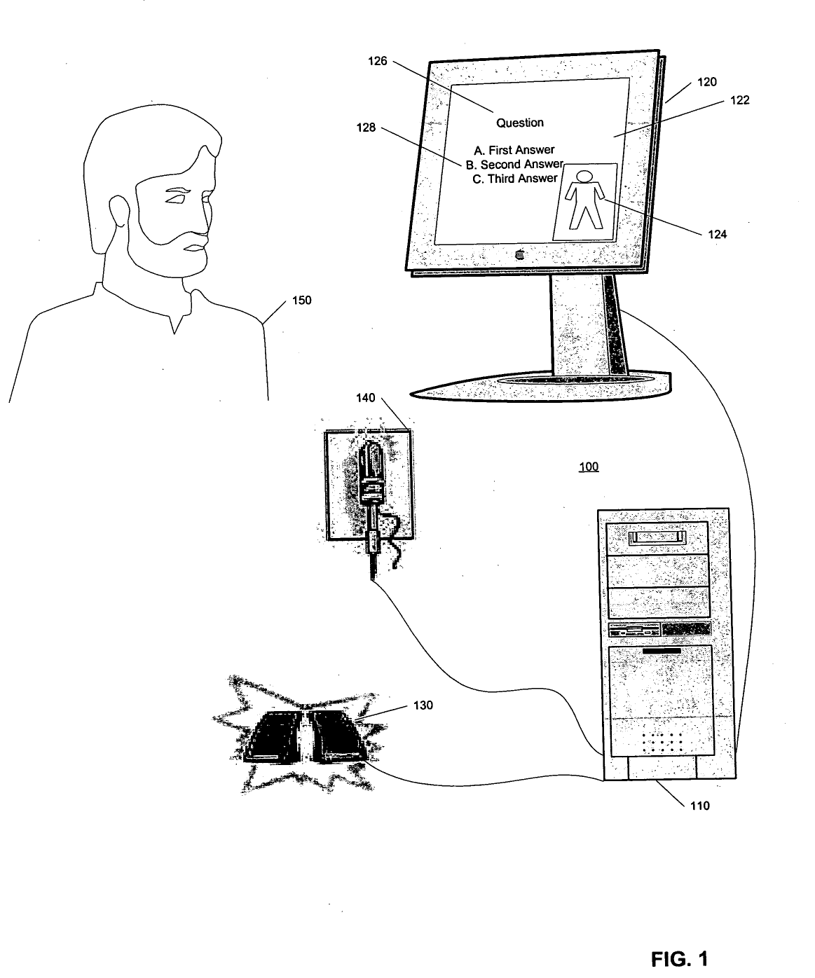

FIG. 1 is an illustration of a system consistent with the present invention in its operating environment. As shown in FIG. 1, a user 150 may interact with a system 100 to conduct a simulated natural conversation with a video display of a Master Teacher 124. Master Teacher 124 preferably is a full motion video image of an actual person. System 100 may comprise a conversation platform 110, a microphone 140 connected to conversation platform 110, one or more speakers 130 connected to conversation platform 110, and a display 120 connected to conversation platform 110. User 150, speaking through microphone 140 and listening through speakers 130 may engage in simulated conversation or take an examination administered by Master Teacher 124 in a natural, conversational tone without any requirement to “train” the system 100 in the speech patterns of user 150.

After user 150 has engaged in learning at least some information from the Master Teacher as described in patent application Ser. No. 10/438,168, user 150 may take an exam administered by Master Teacher 124. User 150 may be provided with one or more questions 126, for example, administered one question at a time, and a series of one or more prompted answers 128. Questions 126 administered by system 100 may be limited to questions concerning subjects in which Master Teacher 124 has already instructed user 150.

As user 150 speaks one of the prompted answers 128 into microphone 140, conversation platform 110 may receive this utterance as audio signals from microphone 140, parse the audio signals, compare the parsed audio signals to an examination database of phonemes to find a matching phrase, and determine whether user 140 has provided a correct or incorrect answer in the matching phrase. Depending on whether user's 150 answer is correct, system 100 may acknowledge correct answers or admonish incorrect answers.

Furthermore, user 150 may request, during the course of questioning, to: have his memory refreshed by replaying lecture material (providing a remembrance); be provided with the correct answer; move to the next question; display his score; or to discontinue the examination.

Consistent with the present invention, one or more authoring processes may also be provided to permit authoring of interactive examinations to be engaged in by user 150. The authoring processes may include a video editing process for generating examination content sequences and answers; and a phoneme generation process to generate phonetic “clones” of answers for storage in the examination database to match the answers to determine if the user has provided a correct or incorrect answer, in a manner to be described below.

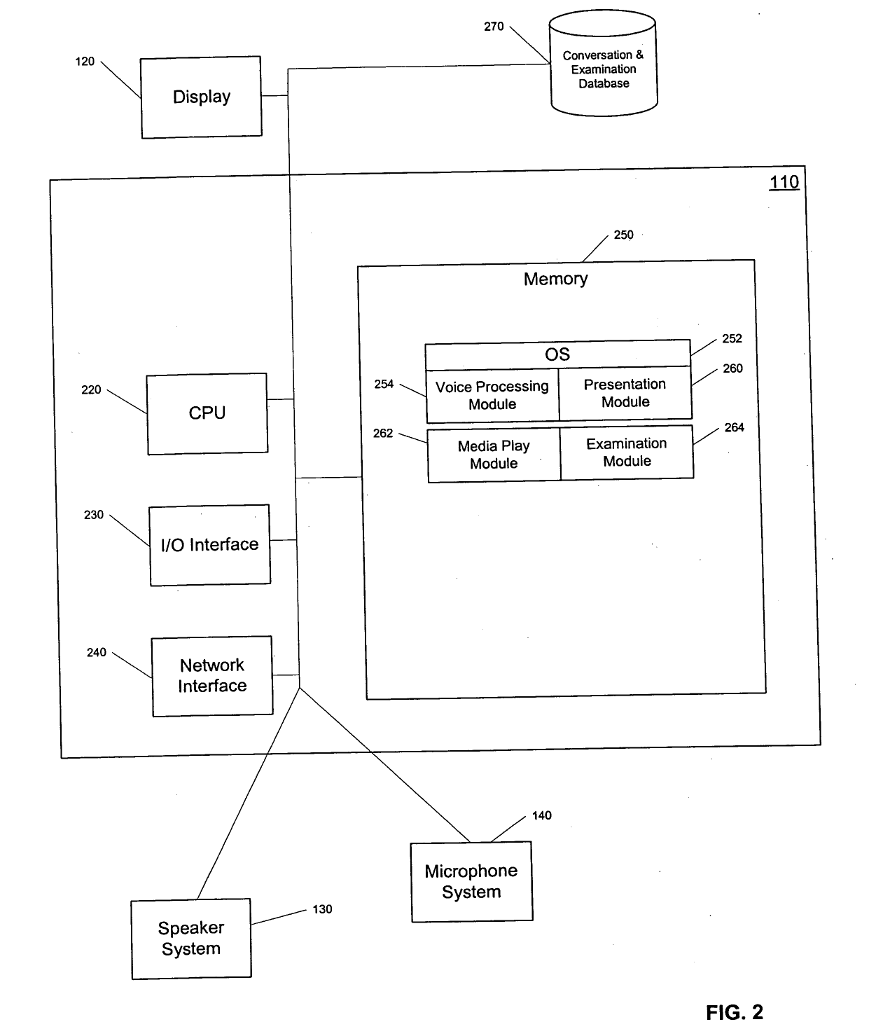

FIG. 2 is a block diagram of a conversation platform 110 consistent with the present invention. As illustrated in FIG. 2, a system environment of conversation platform 110 may include a central processing unit 220, an input/output interface 230, a network interface 240, and memory 250 coupled together by a bus. Conversation platform 110 may be adapted to include the functionality and computing capabilities to utilize interactive conversation sequences in interacting with a user and perform interactive examinations with a user. Conversation platform 110 may be coupled to display 120.

As shown in FIGS. 1 and 2, conversation platform 110 may comprise a PC or mainframe computer for performing various functions and operations consistent with the invention. Conversation platform 110 may be implemented, for example, by a general purpose computer selectively activated or reconfigured by a computer program stored in the computer, or may be a specially constructed computing platform for carrying-out the features and operations of the present invention. Conversation platform 110 may also be implemented or provided with a wide variety of components or subsystems including, for example, at least one of the following: at least one central processing unit 220, a co-processor, memory 250, registers, and other data processing devices and subsystems.

Conversation platform 110 may also communicate or transfer conversation programs and examination scripts via I/O interface 230 and/or network interface 240 through the use of direct connections or communication links to other elements of the present invention. For example, a firewall in network interface 240, prevents access to the platform by unauthorized outside sources.

Alternatively, communication within conversation platform 110 may be achieved through the use of a network architecture (not shown). In the alternative embodiment (not shown), the network architecture may comprise, alone or in any suitable combination, a telephone-based network (such as a PBX or POTS), a local area network (LAN), a wide area network (WAN), a dedicated intranet, and/or the Internet. Further, it may comprise any suitable combination of wired and/or wireless components and systems. By using dedicated communication links or shared network architecture, conversation platform 110 may be located in the same location or at a geographically distant location from systems 120, 130, 140, and 270.

I/O interface 230 of the system environment shown in FIG. 2 may be implemented with a wide variety of devices to receive and/or provide the data to and from conversation platform 110. I/O interface 230 may include an input device, a storage device, and/or a network. The input device may include a keyboard, a microphone, a mouse, a disk drive, video camera, magnetic card reader, or any other suitable input device for providing data to conversation platform 110.

Network interface 240 may be connected to a network, such as a Wide Area Network, a Local Area Network, or the Internet for providing read/write access to interactive conversation sequences, interactive examination scripts, and data in conversation and examination database 270.

Memory 250 may be implemented with various forms of memory or storage devices, such as read-only memory (ROM) devices and random access memory (RAM) devices. Memory 250 may also include a memory tape or disk drive for reading and providing records on a storage tape or disk as input to conversation platform 110. Memory 250 may comprise computer instructions forming: an operating system 252; a voice processing module 254 for receiving voice input from a user and for comparing the voice input to a library of phoneme-based phrases to provide one or more matching phrases; a presentation module 260 for running interactive conversation sequences (to be described in detail below); a media play module 262 for providing multimedia object to a user; and an examination module 264 for running interactive examination scripts.

A conversation and examination database 270 is coupled to conversation platform 110. Interactive conversation sequences, interactive examination scripts, phoneme databases, and clips may be stored on conversation database 270. Conversation and examination database 270 may be electronic memory, magnetic memory, optical memory, or a combination thereof, for example, SDRAM, DDRAM, RAMBUS RAM, ROM, Flash memory, hard drives, floppy drives, optical storage drives, or tape drives. Conversation and examination database 270 may comprise a single device, multiple devices, or multiple devices of multiple device types, for example, a combination of ROM and a hard drive.

While the term “examination script” is used in conjunction with the system, the examination script is less a written series of directions and more a table of examination content sequences linked to answer phrases, such that after an examination content sequence (asking the user a question) is played for the user, a phrase uttered by the user is compared to one or more examination answer phrases. Examination content sequences are stored in the conversation and examination database 270 linked to one or more answers.

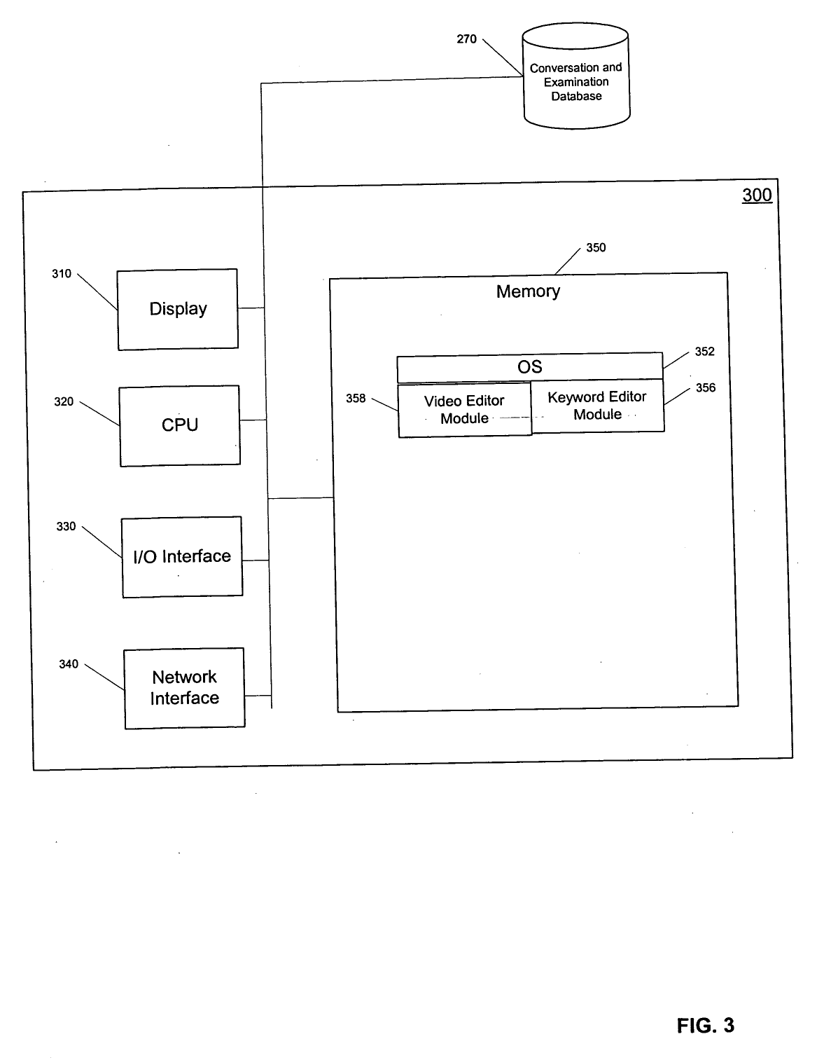

FIG. 3 is a block diagram of an authoring platform 300 consistent with the present invention. As illustrated in FIG. 3, a system environment of authoring platform 300 may include a display 310, a central processing unit 320, an input/output interface 330, a network interface 340, and memory 350 coupled together by a bus. Authoring platform 300 may be implemented on the same computer as conversation platform 110 or on a different computer. Authoring platform 300 may be adapted to include the functionality and computing capabilities to develop examination content sequences used by a conversation platform to examine a user.

As shown in FIG. 3, authoring platform 300 may comprise a PC or mainframe computer for performing various functions and operations consistent with the invention. Authoring platform 300 may be implemented, for example, by a general purpose computer selectively activated or reconfigured by a computer program stored in the computer, or may be a specially constructed computing platform for carrying-out the features and operations of the present invention. Authoring platform 300 may also be implemented or provided with a wide variety of components or subsystems including, for example, at least one of the following: at least one central processing units 320, a co-processor, memory 350, registers, and other data processing devices and subsystems.

Authoring platform 300 may also communicate or transfer examination content sequences via I/O interface 330 and/or network interface 340 through the use of direct connections or communication links to other elements of the present invention. For example, a firewall in network interface 340, prevents access to the platform by unauthorized outside sources.

Alternatively, communication within authoring platform 300 may be achieved through the use of a network architecture (not shown). In the alternative embodiment (not shown), the network architecture may comprise, alone or in any suitable combination, a telephone-based network (such as a PBX or POTS), a local area network (LAN), a wide area network (WAN), a dedicated intranet, and/or the Internet. Further, it may comprise any suitable combination of wired and/or wireless components and systems. By using dedicated communication links or shared network architecture, authoring platform 300 may be located in the same location or at a geographically distant location from conversation database 270.

I/O interface 330 of the system environment shown in FIG. 3 may be implemented with a wide variety of devices to receive and/or provide the data to and from authoring platform 300. I/O interface 330 may include an input device, a storage device, and/or a network. The input device may include a keyboard, a microphone, a mouse, a disk drive, video camera, magnetic card reader, or any other suitable input device for providing data to authoring platform 300.

Network interface 340 may be connected to a network, such as a Wide Area Network, a Local Area Network, or the Internet for providing read/write access to interactive conversation sequences and data in conversation database 270.

Memory 350 may be implemented with various forms of memory or storage devices, such as read-only memory (ROM) devices and random access memory (RAM) devices. Memory 350 may also include a memory tape or disk drive for reading and providing records on a storage tape or disk as input to authoring platform 300. Memory 350 may comprise computer instructions forming: an operating system 352; a keyword editor module 356 for processing phrases into the library of phonemes; and a video editor module 358 for editing examination content clips.

Conversation and examination database 270 is coupled to authoring platform 300. Interactive examination scripts as described previously, phoneme databases, and clips may be stored on conversation and examination database 270. Conversation and examination database 270 may be electronic memory, magnetic memory, optical memory, or a combination thereof, for example, SDRAM, DDRAM, RAMBUS RAM, ROM, Flash memory, hard drives, floppy drives, optical storage drives, or tape drives. Conversation and examination database 270 may comprise a single device, multiple devices, or multiple devices of multiple device types, for example, a combination of ROM and a hard drive.

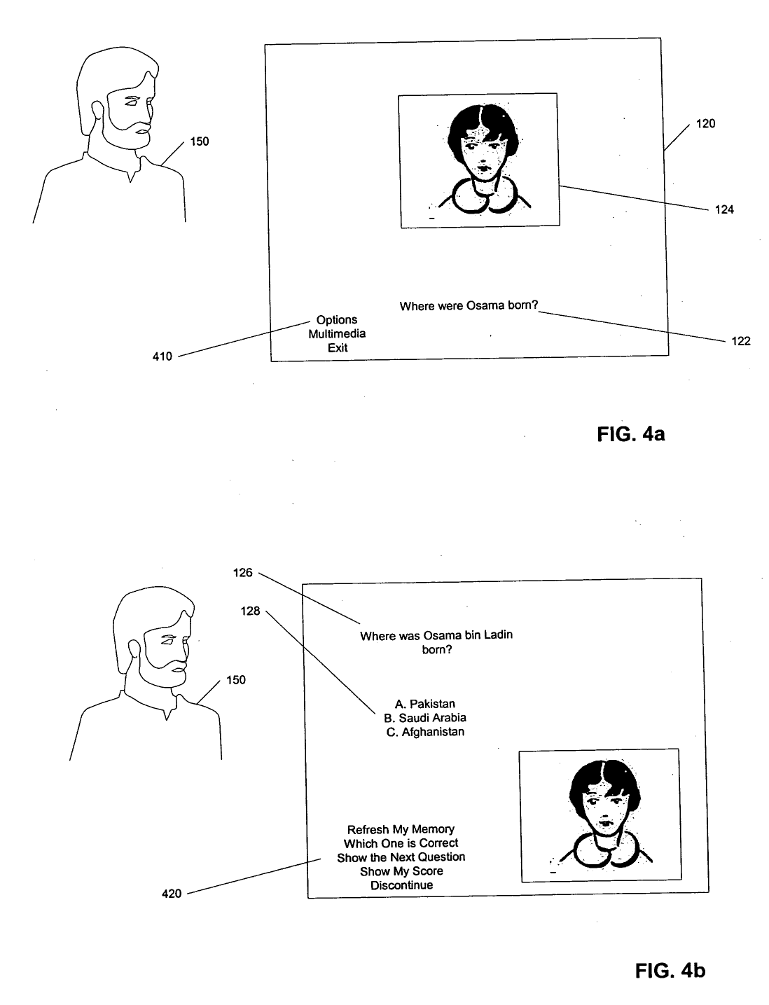

FIG. 4a is an illustration of display screen 120 at a conversation prompting state in a teaching consistent with the present invention. As previously described in application Ser. No. 10/438,168, user 150 may initially be presented with a display 120 having a Master Teacher 124 in a character window in a prompting state, i.e., the subject is in a neutral state awaiting a question or statement, (“phrase”) from user 150. The subject may be displayed as a still picture, or the subject may be displayed through a video clip of the subject in a “listening” state. User 150 may also be presented with one or more prompts 122 that may be related to a particular subject area. Prompts 122 may be shown on display 120 simultaneously, for example, as a list, or may be consecutively flashed on display 120. Prompts 122 assist user 150 in speaking a phrase that is known to an interactive conversation sequence being executed on system 100 to trigger a teaching sequence. Display 120 may also include one or more option areas 410 that display additional phrases, not related to a simulated conversation that may be selected and spoken by user 150.

FIG. 4b is an illustration of display screen 120 during an examination state consistent with the present invention. After user 150 requests an examination by speaking, for example, “Start Examination,” into the microphone, the interactive system 100 may: parse audio signals representing the phrase into phonemes; match the phonemes to a database of phonemes corresponding to a phrase; and, based on the matched phrase, display an interactive examination content sequence of the Master Teacher 124 uttering a question. Interactive system 100 may display the question in text form in question display area 126. User 150 may be presented with one or more answer prompts 128 from which he may select an answer. For example, user 150 may speak “Saudi Arabia” or “B” into the microphone. The interactive system 100 may: parse audio signals representing the spoken audio into phonemes; match the phonemes to a database of phonemes corresponding to answer prompts 128; and determine if user 150 uttered a correct answer.

If the answer is correct, Master Teacher 124 may utter an acknowledgement that the answer is correct, for example, by saying “You are right,” or “That is correct.” Interactive system 100 may randomly select the acknowledgement from a selection of one or more affirmative answers or the answers may be rotated or always be the same.

If the answer is incorrect, Master Teacher 124 may utter an acknowledgement that the answer is incorrect, for example, by saying “You are wrong,” or “That is incorrect.” Interactive system 100 may randomly select the acknowledgement from a selection of one or more negative answers or the negative answers may be rotated or always be the same. If the user is incorrect, Master Teacher 124 may ask user 150 if he would like to have his memory refreshed, and interactive system 100 would play a conversation sequence in the form of a lecture in which the correct answer would be provided to user 150. Also, upon an incorrect answer, interactive system 100 may have Master Teacher 124 prompt user 150 toward the correct answer by providing one or more clues or leads as to the correct answer. During the interactive examination, a score may be maintained of the user's correct and incorrect answers.

Also, during the interactive examination, examination options 420 may be presented to user 150. In lieu of answering a question, a user may utter a phrase corresponding to one of examination options 420. Examination options 420 may include, for example:
“Refresh My Memory,” which would cause interactive system 100 to play a conversation sequence in which the correct answer would be provide to user 150;
“Which One is Correct,” which would cause interactive system 100 to provide the correct answer to user 150;
“Show the Next Question,” which causes interactive system 100 to display the next set of questions and answers;
“Show My Score,” which causes interactive system 100 to display user 150's current examination score; and
“Discontinue,” which ends or pauses the current interactive examination and may return the user to the prompting state illustrated in FIG. 4a.

When a user requests that his memory be refreshed, a computerized artistic transition, such as fade to black, occurs and the Master Teacher display 124 is refreshed with the previous image of the Master Teacher providing a conversation sequence relevant to the question. Upon completion, another computerized artistic transition, such as fade to black, occurs and the Master Teacher display 124 is refreshed with the subject awaiting the student's answer.

In any of the above sequences, system 100 may remove the prompts 122 or option menus 410, 420 from display 120 during the speech state, so as to enhance the impression of being in an actual examination or conversation.

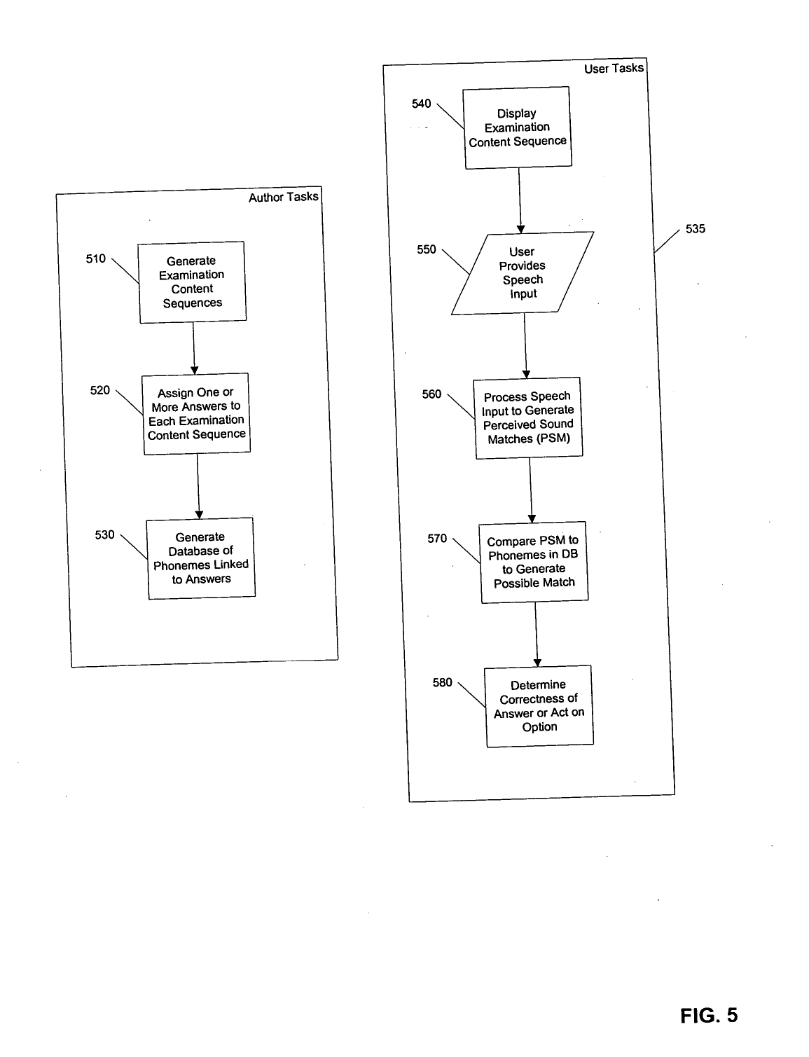

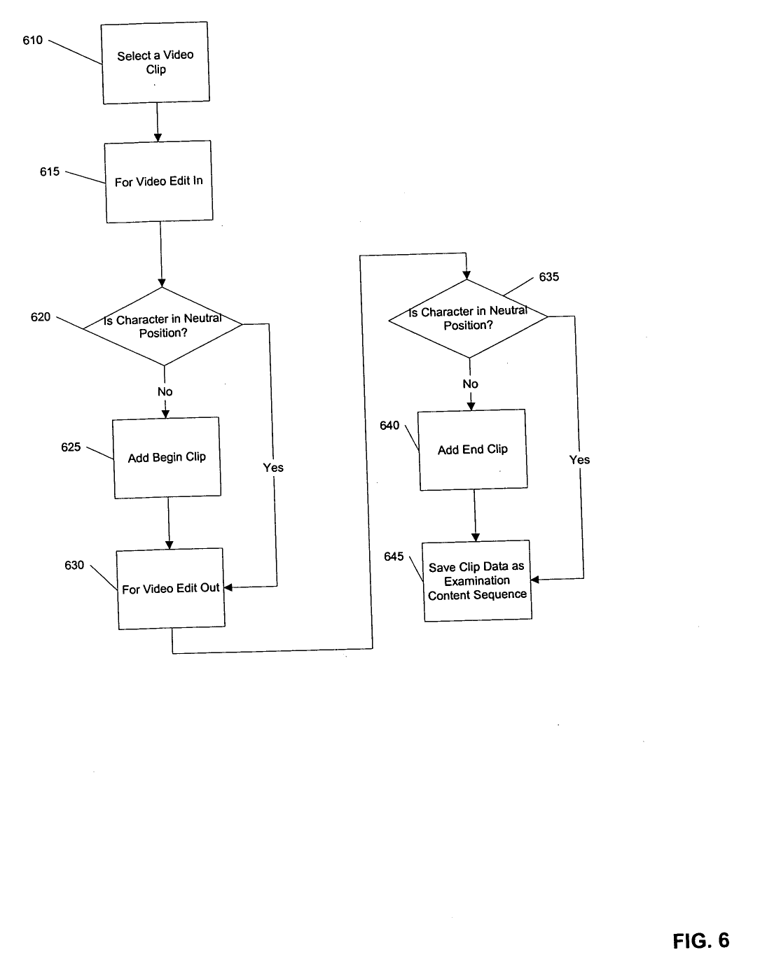

FIG. 5 is a flowchart of an author process and a user interaction process consistent with the present invention. The author process may comprise stages 510, 520 and 530, which may be executed in any order. The author processes may be executed on authoring platform 300. At stage 510, the author may edit signals from one or more video sources into examination content sequences. Examination content sequences may be generated from a video source, such as a video camera recording of a human subject, and saved as individual video files, or examination content sequences may comprise a designated start frame and a designated end frame within a video file to form examination content sequences including content clips, begin clips, and end clips. The author may designate the start frame and the end frame, whereby a pair of values designating the start frame and end frame is stored as designation data of the examination content sequences. Generate examination content sequence process 510 will be explained more fully with respect to FIG. 6.

At stage 520, the author assigns one or more answers to each examination content sequence. Each answer may be linked to one or more answer phrases. As an answer phrase is assigned to an examination content sequence, the phrase may be stored in the conversation and examination.

At stage 530, the author may execute a phoneme generation process, which takes one, or more answer phrases associated with an answer and generates a list of phonemes associated with the answer phrases. This may enhance the speed of the matching process, so that the execution of the interactive examination script with the user proceeds promptly and with little delay. As is known to those of ordinary skill in the art, phonemes are units of specific sound in a word or phrase. For example, “Bull” in “Bullet,” “Kashun” in “Communication,” and “Cy” and “Run” in “Siren.”

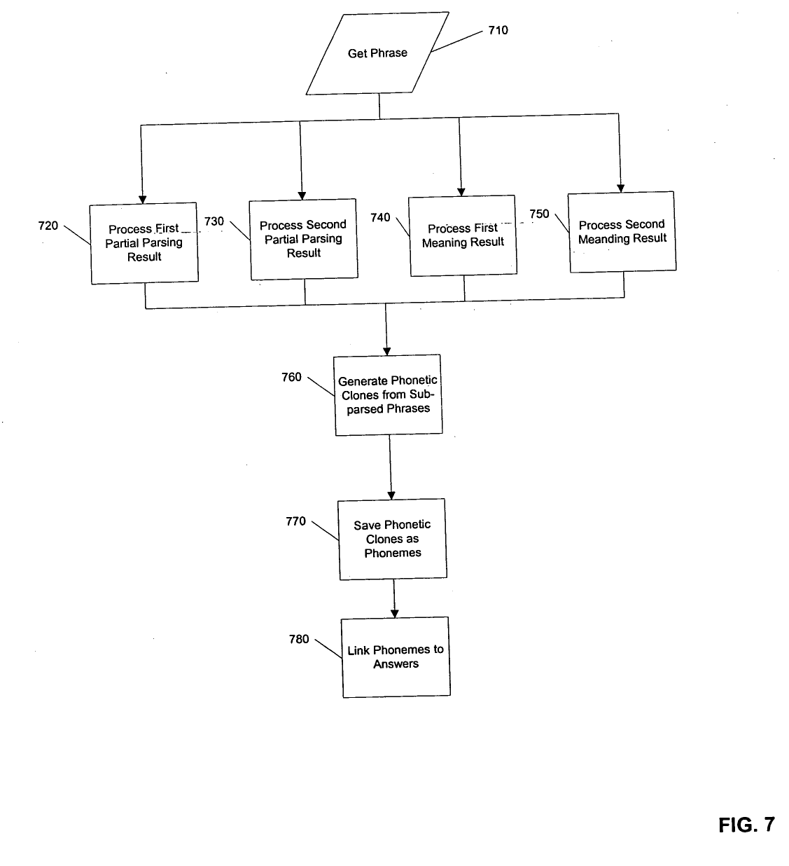

Phonemes may be generated based on portions of the answer phrase, a key word and synonyms of the key word in the answer phrase, or a qualifier and synonyms of the qualifier in the answer phrase. The phoneme generation process is explained more fully in FIG. 7. The end product of the author tasks is a data file known as an interactive examination script, which may be stored in the conversation and examination database.

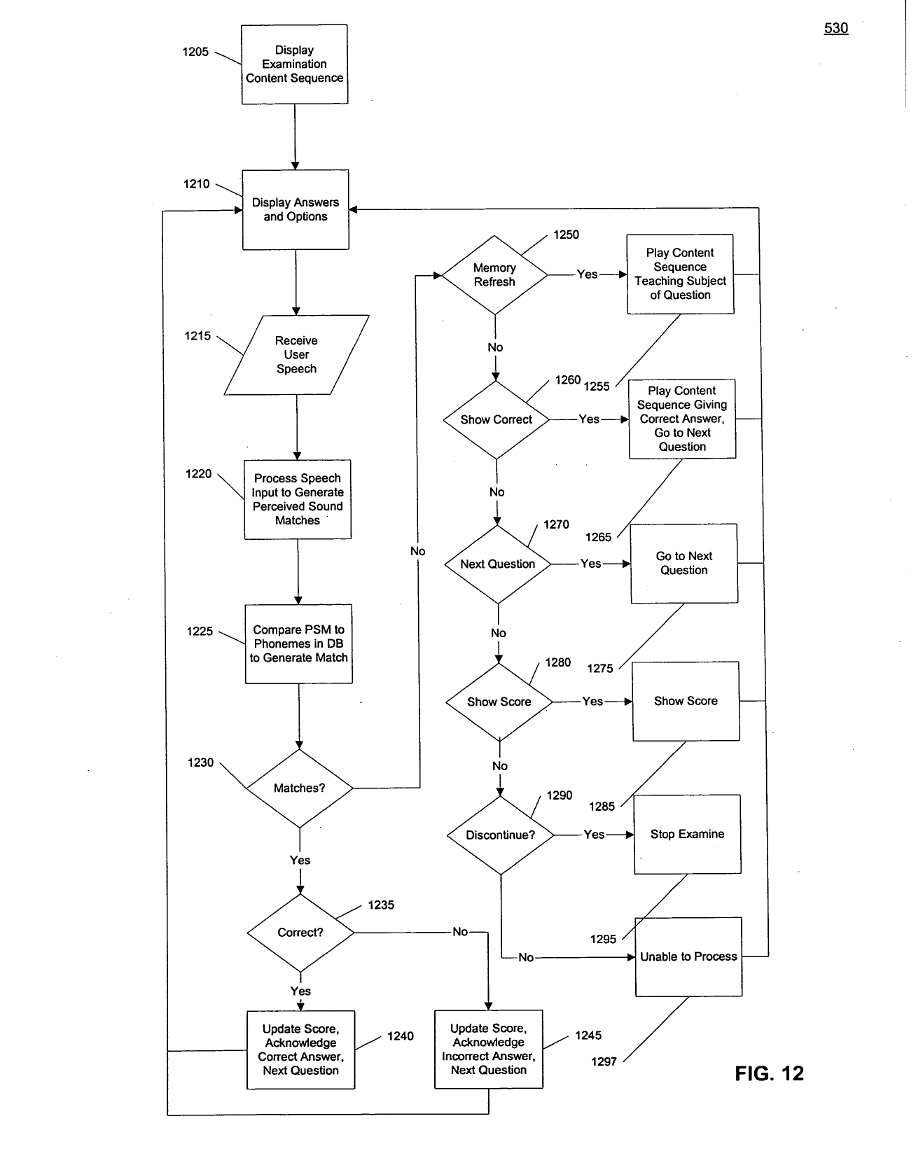

User tasks 535 are those tasks associated with the execution of the interactive communication sequence in system 100 (FIG. 1). At stage 540, the user has begun an examination and an examination content sequence associated with a question is displayed to the user via display 120 and speakers 130. In an exemplary embodiment, the examination content sequence is displayed in a corner of display 120. At stage 550, the user provides an answer as input to interactive system 100 by speaking into microphone 140 (FIG. 1). At stage 560, interactive system 100 processes the input speech to generate one or more perceived sound matches (“PSMs”). At stage 570, the PSMs are compared to the phoneme phrases in conversation and examination database 270 (FIGS. 2 and 3) to generate a list of possibly matching answer phrases. At stage 580, the best matching phrase is determined. If the matching phrase is associated with an answer, the correctness of the answer is determined and the user's score is updated. If the phrase is associated with an option, system 100 takes action appropriate to the option uttered by the user. Thus, an interactive examination may be conducted. User tasks process 535 is explained in more detail with respect to FIG. 12.

FIG. 6 is a flowchart of an examination content sequence generation process 510 (FIG. 5) consistent with the present invention. At stage 610, an author selects a video clip from a plurality of stored multimedia files. The stored multimedia files may be, for example, raw video clips generated by the taping of a subject during an interview process. Raw video clips may be captured to magnetic or optical storage media in, for example, Digital Video (DV) format from source footage of master tapes from an original subject interview. These raw video clips may be compressed using software or hardware digital video codecs such as MPEG3 or MPEG4 standard to form content clips for storage in database 270. The content clips stored in the database may be indexed by subject and stored in the compressed state.

The selection of stage 610 may be performed by selecting a start frame and an end frame for the content clip. At stage 615, the process begins for video edit in, i.e., for the start frame designation. At stage 620, the process checks to see if the subject is not in a neutral position in the start frame, for example, if the subject's mouth is open or if the subject's face is close to the edge of the visual frame. If the subject is not in a neutral position in the start frame, the process, at stage 625, selects a begin clip for frame matching.

The begin clip consists of a short transitional video sequence of the subject moving from a neutral position to the position of the subject in the start frame of the content, or a position close thereto. The process may select from multiple begin clips to select the one with the best fit for the selected content clip. Begin clips may be run in forward or reverse, with or without sound, whichever is better for maintaining a smooth transition to the start frame of the content clip. The begin clip may be physically or logically added to the start of the content clip to form a content sequence. For example, the content sequence may be saved in a file comprising the begin clip and video clip. Or, the begin clip may be designated by a begin clip start frame and a begin clip end frame which may be stored along with the information specifying the content clip start frame and the content clip end frame. Thus, the content sequence data record may comprise the following fields: begin clip file name, begin clip start frame, begin clip stop frame, content clip file name, content clip start frame, and content clip end frame.

At stage 630, the process begins for video edit out, i.e., for the stop frame designation. At stage 635, the process checks to see if the subject is at a neutral position in the stop frame. If the subject is not in a neutral position in the stop frame, the process, at stage 640, selects an end clip for frame matching. The end clip serves as a transitional clip to a neutral position from the position of the subject in the stop frame, or a position close thereto. The process may select from multiple end clips to select the one with the best fit.

End clips may be run in forward or reverse, with or without sound, whichever is better for maintaining a smooth transition to the start frame. The end clip may be physically or logically added to the start of the content clip. For example, the content sequence may be saved in a file comprising the end clip and content clip. Alternatively, the end clip may be designated by an end clip start frame and an end clip end frame that may be stored along with the information regarding the content clip start frame and the content clip end frame. Thus, the content sequence data record may comprise the following fields: content clip file name, content clip start frame, content clip end frame, end clip file name, end clip start frame, and end clip stop frame.

Where both begin clips and end clips are utilized, the content sequence data record may comprise the following fields: begin clip file name, begin clip start frame, begin clip stop frame, content clip file name, content clip start frame, content clip end frame, end clip file name, end clip start frame, and end clip stop frame. Thus, an examination content sequence may be generated for one or more questions and saved (stage 645).

FIG. 7 is a flowchart of a phoneme generating process 530 (FIG. 5) consistent with the present invention. This process may be used by the author to generate a table of phonemes associated with an answer associated with an examination content sequence. At stage 710, the process retrieves the answer to be processed in the form of a text file. Next, the process may implement one or more stages of phrase processing to generate groups of sub-parsed phrases.

Various types of phrase processing may be implemented. In the present embodiment, four phrase processing stages are executed. Specifically, two syntax-based stages, partial parsing stages 720 and 730, are executed and two meaning-based stages, association stages 740 and 750, are executed. Each of these stages yields sub-parsed phrases of the associated phrase.

At stage 760, phonetic clones may be generated of the sub-parsed phrases returned from stages 720-750. Phonetic clones are the phonetic spellings of the sub-parsed phrases or terms. To generate phonetic clones, the author may consider each answer phrase and anticipate the various ways that a user could paraphrase the answer phrase. The author then may anticipate the various ways that a user might pronounce the answer phrase. The author may then develop phonemes as needed for optimal recognition. Phonemes are applied to account for the differences between written and spoken language. For example, “your wife” when spoken will often sound like “urwife,” as if it were a single word. The articulation of both words in “your wife” would be unusual in natural conversation. Unless a phoneme is used to alert the system of such natural speech habits, recognition may be made more difficult, though not impossible, and the continuity of the virtual examination may be disrupted.

To illustrate some further example of the process, sub-parsed phrase “in school” may yield the phonetic clones “enskool” and “inskul,” “when you married” may yield “winyoomarried” and wenyamarried,” and “to college” may yield “tuhcallidge” and toocawlige.” At stage 770, the phonetic clones are saved in a phoneme data file as a phoneme text file associated with the answer. At stage 780, the generated phonemes are linked to the answer.

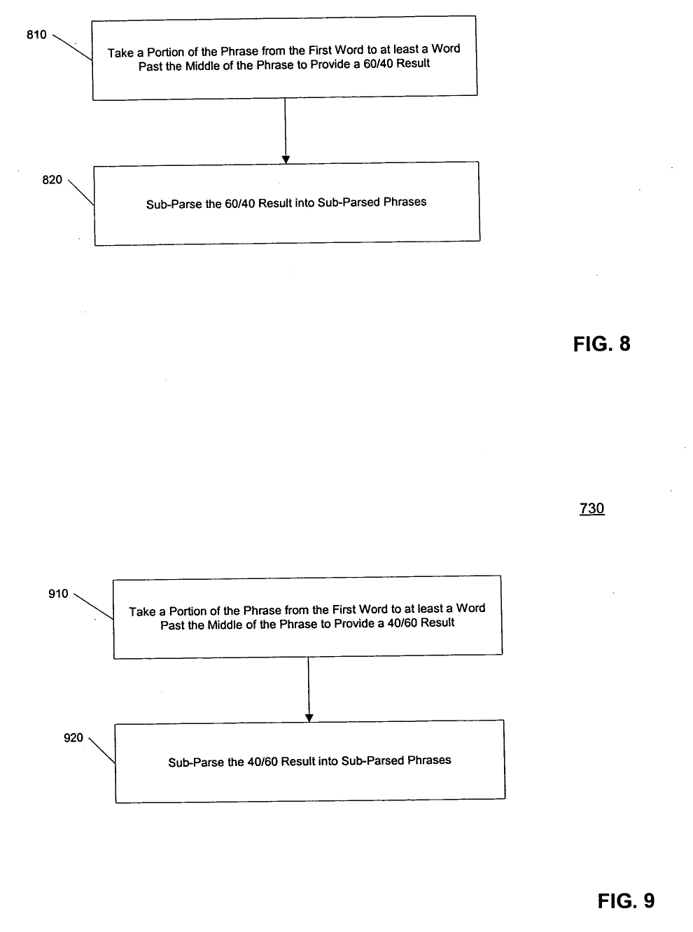

FIG. 8 is a flowchart of first partial processing stage 720 consistent with the present invention. Stage 720 is a partial processing stage, specifically, a “60/40” parsing stage, that is 60%/40%. At stage 810, a majority of the associated answer phrase, beginning with the first word of the phrase is parsed from the phrase. For example, the answer phrase “He was born in Saudi Arabia” may be 60/40 parsed as “He was born in.” At stage 820, the 60/40 result is sub-parsed into one or more sub-phrases. For example, sub-parsing the 60/40 parsed phrase “He was born in” may yield sub-parsed phrases “he was,” “born in,” and “was born,” each consisting of at least half of the parsed phrase “He was born in” and each beginning with a different word counted from the beginning of the parsed phrase.

FIG. 9 is a flowchart of second partial processing stage 730 consistent with the present invention. Stage 730 is a partial parsing stage similar to stage 720 (FIG. 8), except that parsing begins from the end of the associated phrase, rather than the beginning as in stage 720. Stage 730 is referred to as a “40/60” stage. Thus, at stage 910, a majority of the associated phrase, ending with the last word of the phrase is parsed from the phrase. For example, the phrase “He was born in Saudi Arabia” may be 40/60 parsed as “was born in Saudi Arabia.” At stage 920, the 40/60 result is sub-parsed into one or more phrases. For example, sub-parsing the 40/60 phrase “was born in Saudi Arabia” may yield the sub-parsed phrases “was born,” “Saudi Arabia,” and “born in.”

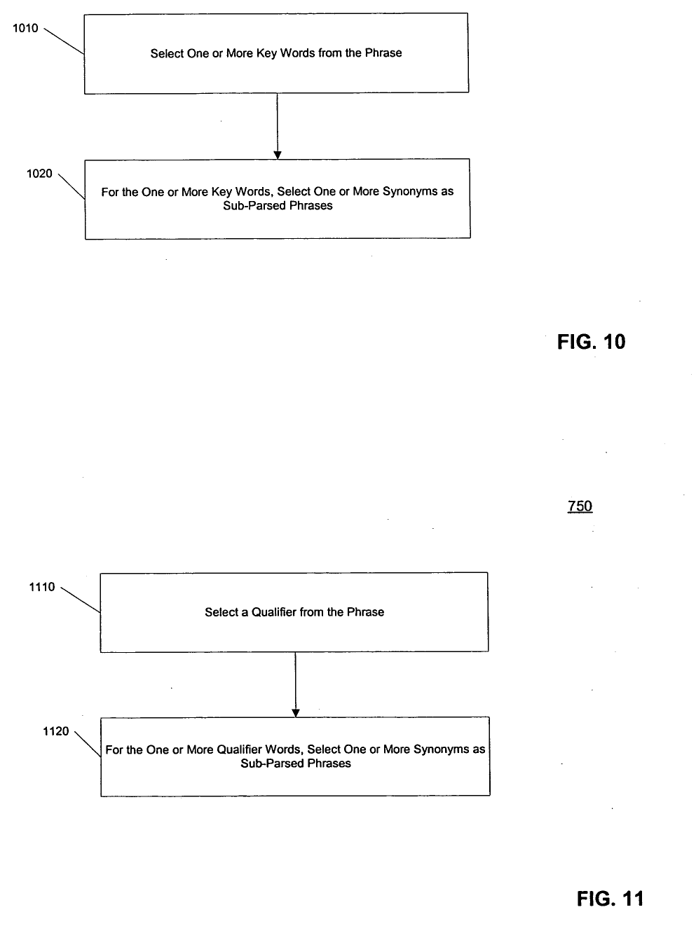

FIG. 10 is a flowchart of first meaning-based process, association process 740, consistent with the present invention. Specifically, 740 is a type of meaning-based process known as a “keyword” process. Keywords may be nouns or noun phrases that depict a central topic or idea of an answer. For example, for the phrase “He was born in Saudi Arabia” a keyword might be “Saudi Arabia.” At stage 1010, one or more keywords are selected from the associated phrase, based on meanings of words in the associated phrase. At stage 1020, terms with similar meaning may be generated for the keyword. For example, the keyword “Saudi Arabia” may yield, “Arabia,” “Saudi,” and “Riyad.”

FIG. 11 is a flowchart of second meaning-based process 750 consistent with the present invention, based on “qualifiers.” Qualifiers may be adjectives or adjective phrases that modify the intention or meaning of an answer. For example, in the answer “He was born in Saudi Arabia” the keyword is “Saudi Arabia” and the qualifier is “was born.”

At stage 1110, one or more qualifiers are selected from the answer phrase.

For example, for the answer phrase “He was born in Saudi Arabia” a qualifier might be “born in.” At stage 1020, synonyms may be generated for the qualifier. For example, the qualifier “born in” may yield, for example, the synonyms “raised,” “was from,” “nurtured.”

FIG. 12 is a more detailed flowchart of an interactive examination process consistent with the present invention. At stage 1205, the Master Teacher may be displayed in a corner of the display 120 asking a question of the user through system 100 playing an examination content sequence. In addition, the question associated with the examination content sequence may be displayed to the user. At stage 1210, one or more answers to the examination content sequence is displayed to the user. One or more options may also be displayed to the user. The options may include, for example: refresh my memory; show the correct answer; next question; show score; and discontinue examination.

At stage 1215, an utterance from a user is received as the answer to the question presented in the examination content sequence. At stage 1220, the utterance is processed to generate a list of perceived sound matches (“PSM”) in the form of text. At stage 1225, the PSM are compared to the library of stored phonemes, also in text form, to generate a list of matches. The phonemes in the library that match the utterance are selected and prioritized according to the closeness of the sound match on the basis of scores. A predetermined number of these prioritized phonemes may be passed to the system for scoring to determine whether a valid recognition has occurred. The score of each phoneme may be arrived at by multiplying the number of discernable letters in the PSM by a priority number set by the author. The sum of all of the products from the matches to the utterances may be utilized to determine if a recognition, or match, has occurred. (stage 1230). A match occurs if the sum is equal to or greater than a threshold level set by the author.

If a match to an answer phoneme occurs, at stage 1235, the answer is checked to see whether it is a correct answer for the examination content sequence. If it is a correct answer, Master Teacher 124 may acknowledge that a correct answer has been given. For example, he may say “That is correct” or “Yes, that is right.” Interactive system 100 may randomly select the acknowledgement from a selection of one or more affirmative answers or the answers may be rotated or always be the same. Interactive system 100 may update the score. The next question may then be presented to the user as processing returns to stage 1205.

If the answer is incorrect (stage 1245), Master Teacher 124 may utter an acknowledgement that the answer is incorrect, for example, by saying “No, that is not right,” or “That is incorrect.” Interactive system 100 may randomly select the acknowledgement from a selection of one or more negative answers or the negative answers may be rotated or always be the same. If the user is incorrect, Master Teacher 124 may ask user 150 if he would like to have his memory refreshed, and interactive system 100 would play a conversation sequence in which the correct answer would be provided to user 150. Also, upon an incorrect answer, interactive system 100 may have Master Teacher 124 prompt user 150 toward the correct answer by providing one or more clues or leads as to the correct answer. Interactive system 100 may update the score. The next question may then be presented to the user as processing returns to stage 1205.

If a match to an answer has not occurred, at stage 1250, a check is made to see if the utterance was a request for a memory refresh. If so, at stage 1255, interactive system 100 would play a conversation sequence in which the correct answer would be provided to user 150. The next question may then be presented to the user as processing returns to stage 1205.

If the utterance was not a memory refresh, at stage 1260 a check is made to see if the utterance was a request for the correct answer. If so, at stage 1265, the Master Teacher 124 may provide the correct answer to the user. The next question may then be presented to the user as processing returns to stage 1205.

At stage 1270, a check is made to see if the utterance was a request to move to the next question. If so, at stage 1275, the option is executed. The next question may then be presented to the user as processing returns to stage 1205.

At stage 1280, a check is made to see if the utterance was a request to provide the user with his score. If so, at stage 1285, the user's score is provided to the user. The next question may then be presented to the user as processing returns to stage 1205.

At stage 1290, a check is made to see if the utterance was a request to discontinue the exam. If so, at stage 1295, the examination is halted. The next question may then be presented to the user as processing returns to stage 1205.

If none of these situations matches, at stage 1297, the system determines that it cannot process the utterance. The system may return to stage 1210 or the system may play a content sequence whereby the subject states that he cannot understand the answer. For example, the subject may state “I'm sorry. I didn't understand your answer,” or “I'm having trouble hearing you, will you please repeat your answer?”

At any point in time in the above-described process, the user may halt the process by issuing an utterance, such as “Stop.” This utterance is processed by the system and recognized as a command to halt the process. Halting the process may return the process to stage 1210. While halting the examination, the process may attempt to not compromise the believability of the situation by returning the subject to the neutral position. The process may also utilize aspects of the end clip associated with the playing video clip to maintain believability. For example, the process may take one or more frames from the end of the content clip and one or more frames from the end of the end clip and utilize these frames to transition the subject to the neutral position.

Those skilled in the art will appreciate that all or part of systems and methods consistent with the present invention may be stored on or read from other computer-readable media, such as: secondary storage devices, like hard disks, floppy disks, and CD-ROM; a carrier wave received from the Internet; or other forms of computer-readable memory, such as read-only memory (ROM) or random-access memory (RAM).

Furthermore, one skilled in the art will also realize that the processes illustrated in this description may be implemented in a variety of ways and include multiple other modules, programs, applications, sequences, processes, threads, or code sections that all functionally interrelate with each other to accomplish the individual tasks described above for each module, sequence, and daemon. For example, it is contemplated that these programs modules may be implemented using commercially available software tools, using custom object-oriented, using applets written in the Java programming language, or may be implemented as with discrete electrical components or as at least one hardwired application specific integrated circuits (ASIC) custom designed just for this purpose.

It will be readily apparent to those skilled in this art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

1. A method of generating an interactive examination between a user and a teacher, comprising:
assigning a phrase associated with a correct answer to a question stored as an examination content sequence, wherein the examination content sequence comprises one of a content clip of the teacher posing the question or the question in text form;
assigning a phrase associated with an incorrect answer to the question;
parsing the phrases to produce respective phonetic clones; and
associating the respective phonetic clones with the respective answers.

2. The method of claim 1, wherein parsing the phrases to produce respective phonetic clones further comprises:
selecting a keyword from the phrases;
selecting at least one synonym of the keyword; and
generating at least one phonetic clone of the at least one synonym of the keyword.

3. The method of claim 1, wherein parsing the phrases to produce the respective phonetic clones further comprises:
selecting a qualifier from the phrases;
selecting a synonym of the qualifier; and
generating a phonetic clone of the synonym of the qualifier.

4. The method of claim 1, further comprising:
generating a memory refresh phrase;
parsing the memory refresh phrase to produce phonetic clones of the memory refresh phrase; and
associating the memory refresh phonetic clones with the memory refresh phrase.

5. The method of claim 1, further comprising:
generating a show correct phrase;
parsing the show correct phrase to produce phonetic clones of the show correct phrase; and
associating the show correct phonetic clones with the show correct phrase.

6. The method of claim 1, further comprising:
generating a next question phrase;
parsing the next question phrase to produce phonetic clones of the next question phrase; and
associating the next question phonetic clones with the next question phrase.

7. The method of claim 1, further comprising:
generating a show score phrase;
parsing the show score phrase to produce phonetic clones of the show score phrase;
associating the show score phonetic clones with the show score phrase;

8. A method of administering an interactive examination between a user and a teacher, comprising:
displaying the examination content sequence;
receiving an utterance from the user;
matching the utterance to one of a phonetic clone associated with a correct answer and a phonetic clone associated with an incorrect answer; and
determining if the utterance is associated with the correct answer.

9. The method of claim 8, wherein matching the utterance to one of the phonetic clones further comprises:
processing the utterance to generate a perceived sound match;
comparing the perceived sound match to at least one of the phonetic clones;
performing an arithmetic operation on the phonetic clone and the perceived sound match to generate a result;
comparing the result to a threshold amount; and
if the result is greater than the threshold amount, determining that a match has been found.

10. The method of claim 8, further comprising, if the utterance is associated with the correct answer, displaying a content sequence of the teacher acknowledging the correct answer.

11. The method of claim 10, wherein the content sequence of the teacher acknowledging the correct answer is randomly selected.

12. The method of claim 8, further comprising, if the utterance is associated with an incorrect answer, displaying a content sequence of the teacher acknowledging the incorrect answer.

13. The method of claim 12, wherein the content sequence of the teacher acknowledging the incorrect answer is randomly selected.

14. The method of claim 12, further comprising displaying a content sequence of the teacher aiding the student in determining the correct answer.

15. The method of claim 8, further comprising:
matching the utterance of the user to one of a phonetic clone of a memory refresh phrase; and
if a match is found, displaying a content sequence of the teacher to refresh the memory of the user.

16. The method of claim 8, further comprising:
matching the utterance of the user to a show correct phonetic clone associated with a show correct phrase; and
if a match is found, displaying a content sequence of the teacher providing the correct answer to the user.

17. The method of claim 8, further comprising:
matching the utterance of the user to a next question phonetic clones associated with a next question phrase; and
if a match is found, displaying an examination content sequence associated with a second question to the user.

18. The method of claim 8, further comprising:
scoring the user based on the utterance being associated with a correct answer.

19. The method of claim 18, further comprising:
matching the utterance of the user to a show score phonetic clone associated with a show score phrase; and
if a match is found, displaying a score of the user.

20. A system for administering an interactive examination between a user and a teacher, the system comprising:
a display for displaying the teacher;
a memory; and
a processor, coupled to the memory and the display, the processor operable to:
display an examination content sequence;
receive an utterance from the user;
match the utterance to one of a phonetic clone associated with a correct answer and a phonetic clone associated with an incorrect answer; and
determine if the utterance is associated with the correct answer.

21. A system for generating an interactive examination between a user and a teacher, the system comprising:
a display for displaying the teacher;
a memory; and
a processor, coupled to the memory and the display, the processor operable to:
assign a phrase associated with a correct answer to a question stored as an examination content sequence, wherein the examination content sequence comprises one of a content clip of the teacher posing the question or the question in text form;
assign a phrase associated with an incorrect answer to the question;
parse the phrases to produce respective phonetic clones; and
associate the respective phonetic clones with the respective answers.

22. A computer readable medium containing instructions for administering an interactive examination between a user and a teacher, the instructions being capable of causing a processor to:
display an examination content sequence;
receive an utterance from the user;
match the utterance to one of a phonetic clone associated with a correct answer and a phonetic clone associated with an incorrect answer; and
determine if the utterance is associated with the correct answer.

23. A computer readable medium containing instructions for generating an interactive examination between a user and a teacher, the instructions being capable of causing a processor to:
assign a phrase associated with a correct answer to a question stored as an examination content sequence wherein the examination content sequence comprises one of a content clip of the teacher posing the question or the question in text form;
assign a phrase associated with an incorrect answer to the question;
parse the phrases to produce respective phonetic clones; and
associate the respective phonetic clones with the respective answers.
